(19) United States
(12) Patent Application Publication
(10) Pub. No.: US 2008/0301816 A1
(43) Pub. Date: Dec. 4, 2008

(54) Method and system for handling keystroke commands

(76) Inventors: David M. T. Ting, Sudbury, MA (US); Daniel V. Eskenazi, Arlington, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 11/809,791

(22) Filed: Jun. 1, 2007

(51) Int. Cl. H04L 9/00

(52) U.S. Cl. 726/26

(57) ABSTRACT

Keystroke commands are safeguarded from keyboard logging malware based on a destination application's memory address.

### TECHNICAL FIELD

This invention relates to a method and system for handling keystroke commands and, more particularly, to a method and system for safeguarding keystroke commands from keyboard logging malware.

### BACKGROUND INFORMATION

In the United States and elsewhere, computers have become part of everyday life, both in the workplace and in personal endeavors. This is because inexpensive, general-purpose computers run a variety of software programs that provide sophisticated processing and networking functions. With the advent of global communications networks such as the Internet, computers can now be connected in a “virtual network”—thus allowing companies and people to retrieve and share vast amounts of data, including software programs. The ability to distribute software programs using the Internet quickly and at a significantly reduced cost when compared to traditional means (e.g., diskettes, CD-ROMs) has made the delivery of software an almost trivial exercise.

Along with these benefits, however, come opportunities for mischievous and even illegal behavior. Unwanted software programs are distributed throughout the Internet in order to elicit information from unsuspecting users, take control over individual computers, alter computer settings, and in some cases even disable entire networks. The threat posed by such malicious software (“malware”) is well-documented and continues to grow. Furthermore, the sophistication and covert nature of malware seem to outpace industry's attempts to contain it.

Keyboard logging is a common process by which malware is selectively tuned to work with specific applications or logon forms and as a result can “capture” keystrokes entered by a user. Once logged, a listing of the captured keystrokes can be hidden on the machine for later retrieval using other malware, or sent to another device or server acting as a central repository for the attacking malware. The keystroke commands can then be scanned for passwords, credit card numbers, or other information which can be used to compromise the system and/or to perpetrate fraud. One common example is a key logging application that captures logon credentials entered by a user logging into an application.

Another challenge facing system administrators is the proliferation of login credentials and passwords. To address this issue, numerous single-sign-on (“SSO”) systems have been designed to minimize the number of times that a user must provide authentication credentials in order to gain access to multiple applications. In general, enterprise-based SSO solutions store individual application credentials at a central location (or in some cases using distributed agents) and users need only provide one credential (e.g., a system-wide password, biometric credential, etc.) to authenticate to the SSO system. Once authenticated, the SSO system automatically provides the necessary IDs and/or passwords for the individual applications. However, the existence of malware, specifically malware that traps, logs, and transmits keyboard commands as entered at a client, threatens the security of the system on which it is installed.

What is needed, therefore, is a method and system that can protect keyboard commands from being captured by keystroke-logging malware applications.

### SUMMARY OF THE INVENTION

In SSO credentialing, a client-resident SSO agent automates the logon experience by injecting a user's application logon credentials into a form by setting values of application controls or by simulating keystrokes. Unfortunately, in some circumstances keystroke-logging malware can capture the injected credentials from the application or directly from the SSO agent provided as part of the user provisioning process. To combat such techniques, the invention provides techniques for blocking keystroke events passed from the operating system to any callback procedure that is outside the address space of known, approved applications. This blocking can take place while the SSO agent is injecting credentials and is designed to protect the SSO credentials from being distributed beyond the target application, thus allowing the SSO agent to protect the confidentiality of the logon credentials, as well as other sensitive data.

In preferred embodiments, the present invention safeguards keystroke commands from key-logging malware by identifying applications that are deemed to be legitimate applications and limiting the presentation of the commands to those applications. The invention identifies the legitimate applications based on a memory address (or addresses) associated with that application. Keystroke commands are sent only to the memory addresses associated with the legitimate applications and, as a result, the keystroke commands are not presented to applications residing in unauthorized memory addresses, such as those associated with malware.

Accordingly, in a first aspect, a method for handling keystroke commands includes monitoring keystroke commands being presented to a computer system and handling the keystrokes based on a memory address attributed to an application to which the keystroke commands are being directed. This safeguards the keystrokes from malware such as keystroke-logging applications.

In some embodiments, the keystroke commands represent logon credentials, which may automate logon procedures by, for example, being injected into a form. The monitoring of the keystroke commands can be accomplished by intercepting messages in a message queue. In certain implementations, a client agent intercepts messages by hooking into the message queue by substituting a callback function with a wrapper function. The client agent can process the keystroke commands based on how the keystroke commands are handled, and can either call or bypass the callback function. Bypassing the callback function can result in blocking an application from receiving the keystroke commands. In one embodiment, the method includes determining if the application to which the keystroke commands are being sent is deemed to be an authorized application.

In another aspect, a system for handling keystroke commands directed to an application, where the application is associated with a memory that includes a client-resident agent. The agent monitors and handles the keystroke commands based on the memory address associated with the application.

The keystroke commands can comprise logon credentials and the client-resident agent can further automate a logon procedure. In one embodiment, the client-resident agent automates the logon procedure by injecting user credentials into a form. The system can monitor the keystroke commands by intercepting messages in a message queue, such as by hooking into the message queue. For example, the client-resident agent may hook into the message queue by substituting a wrapper function for a callback function. In some versions, the client-resident agent processes the keystroke commands based on how they are handled. For instance, the client-resident agent can either call the callback function or bypass the callback function, resulting in blocking the keyboard commands from being received by another application. The system can also include a data storage module for storing a list of authorized applications, and in some embodiments can further store the memory addresses allocated to the authorized applications.

In another aspect, the invention comprises an article of manufacture having a computer-readable medium with the computer-readable instructions embodied thereon for performing the methods described in the preceding paragraphs. In particular, the functionality of a method of the present invention may be embedded on a computer-readable medium, such as, but not limited to, a floppy disk, a hard disk, an optical disk, a magnetic tape, a PROM, an EPROM, CD-ROM, or DVD-ROM. The functionality of the techniques may be embedded on the computer-readable medium in any number of computer-readable instructions, or languages such as, for example, FORTRAN, PASCAL, C, C++, Java, C#, Tcl, BASIC and assembly language. Further, the computer-readable instructions may, for example, be written in a script, macro, or functionally embedded in commercially available software (such as, e.g., EXCEL or VISUAL BASIC).

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 is a block diagram of a system to authenticate a user and automate login procedures to one or more applications in accordance with one embodiment of the invention.

FIG. 2 is a block diagram of the client of FIG. 1 including a malware application.

FIG. 3 is a block diagram of the client of FIG. 1 including a malware application and application and memory address data in accordance with one embodiment of the invention.

FIG. 4 is a flow diagram of a process to safeguard keystrokes provided to applications in accordance with one embodiment of the invention.

### DETAILED DESCRIPTION

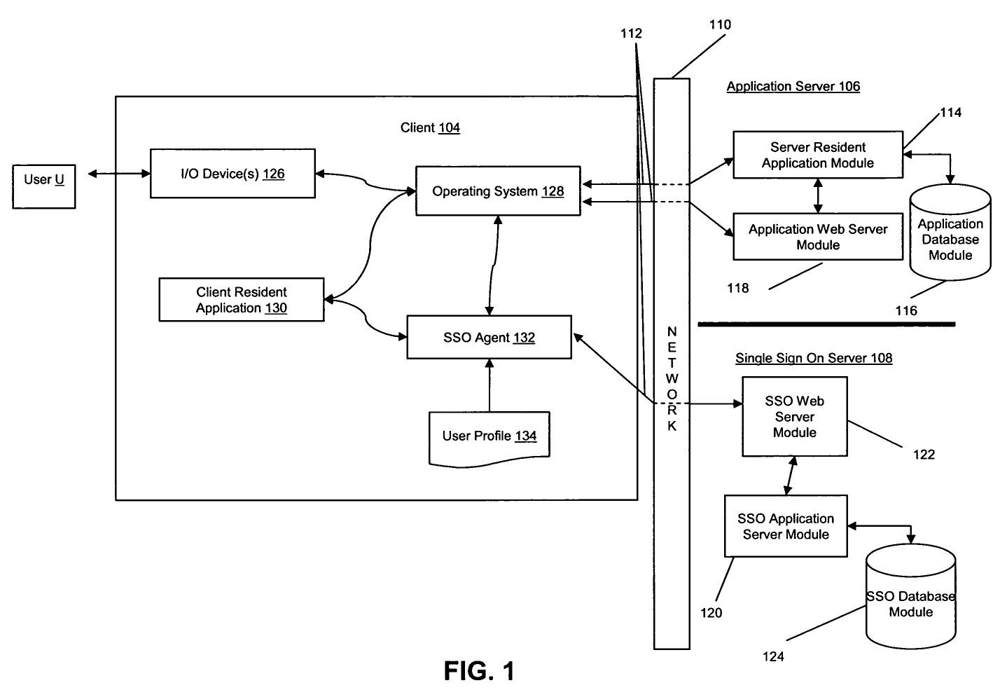

In broad overview, FIG. 1 illustrates an embodiment of a system 100 to safeguard authentication data being transmitted during automated login processes in accordance with various embodiments of the invention. The system 100 includes a first computing system (a “client”) 104, a second computing system (an “application server”) 106 and a third computing system (a “SSO server”) 108, all in communication with a network 110. The client node 104 is used by one or more users, U. The client node 104, the application server 106 and the SSO server 108 are in communication with the network 110 using conventional communication channels 112.

For example, the communication channels 112 can connect the client 104 to a local-area network (LAN), such as a company Intranet, a wide area network (WAN) such as the Internet, or the like. The client 104 and servers 106, 108 communicate with the network 110 through the communication channels 112 using any of a variety of connections including, for example, standard telephone lines, LAN or WAN links (e.g., T1, T3, 56 kb, X.25), broadband connections (ISDN, Frame Relay, ATM), wireless connections, and the like. The connections can be established using a variety of communication protocols (e.g., HTTP(S), TCP/IP, SSL, IPX, SPX, NetBIOS, Ethernet, RS232, direct asynchronous connections, a proprietary protocol, and the like). In one embodiment, the client 104 and the servers 106, 108 encrypt all communication when communicating with each other.

Each of the servers 106, 108 can be any computing device capable of providing the services requested by the client 104. Particularly, this includes logging into secure applications, tracking user activities within applications, and terminating a user's access to applications as described in more detail below.

The application server 106 includes one or more server-resident application modules 114 and one or more application database modules 116 that provide the application logic and data for one or more server-resident applications. The application server 106 may also include an application web server module 118 to facilitate communication with the client 104 over the network 110 using the HTTP protocol, where the communication network 110 is the Internet, an intranet, or the like. The SSO server 108 includes a SSO application server module 120, a SSO web server module 122, and a SSO database module 124. The modules throughout the specification can be implemented in whole or in part as a software program and/or as a hardware device (e.g., ASIC, FPGA, processor, memory, storage and the like).

For purposes of illustration, FIG. 1 depicts an application server 106 as an entity separate and distinct from the SSO server 108 and each server in independent communication with the network 110. It is to be understood, however, that the servers 106, 108 can also be implemented, for example, on a single physical server (e.g., as logically distinct modules), distributed on portions of several (i.e., more than two) servers, and/or as part of a single server node or server farm in communication with the network 110 through, for example, a single web server (not shown). It should further be understood that even if two logical servers are running in the same physical machine, they may be secured logically if any of the following conditions are met: (1) the servers run in different process spaces (so there is no possibility for one process to access the memory of another process); (2) the servers access different logical databases (which may be further partitioned) with different credential or entry requirements; (3) sensitive data in the application server 106 and the SSO server 108 are encrypted using separate encryption keys; or (4) the server applications are launched (e.g., in a Unix environment) under two different logon accounts. For heightened security, it is possible to encrypt all the data used by the SSO server 108 using a key maintained by the application server 106 or an external key server. This approach enhances security because a breach of the of the SSO server 108 and its database 124 would yield only encrypted data.

The client 104 can be any computing device (e.g., a personal computer, set top box, wireless mobile phone, handheld device, personal digital assistant, kiosk, etc) used to provide a user interface to access the application server 106. The client 104 includes one or more input/output devices 126 such as a keyboard, a mouse, a screen, a touch-pad, a biometric input device, and the like. The client 104 also includes an operating system 128. Operating systems supported by the client 104 can include, for example, any member of the WINDOWS family of operating systems from Microsoft Corporation, LINUX, etc. The client 104 may also include one or more client-resident applications 130, such as INTERNET EXPLORER marketed by Microsoft Corporation, NETSCAPE NAVIGATOR marketed by AOL Time Warner, or ATTACHMATE marketed by Attachmate Corporation.

To use the system 100, a user 102 registers his or her authentication data for one or more applications 114 with the application server 106. The authentication data can include, for example, a password, a user identification number, or biometric data associated with the individual's fingerprint(s), facial characteristics, voice, or the like. The system 100 stores authentication data identifying the user to the system (e.g., username, logon ID, employee ID, or the like) in the application database module 116. The application database module 116 may also associate an alias with that stored data. For example, employee #2054 may be associated with the alias 719jLL01. As the user logs into an application 114 (residing on the application server 106) via the network 110, a SSO agent 132 residing on the client 104 captures the authentication data entered by the user 102 using one or more input devices 126 and transmits (or causes the transmission of) the authentication data to the SSO web server module 122 residing on the SSO server 108. The SSO agent 132 captures the data by, for example, monitoring a messaging queue for instructions sent to and from the operating system, intercepting HTTP requests sent to and from the network 110, capturing screen images sent to the output device(s) 126, or by any other suitable technique. The SSO web server module 122 provides the authentication data to the SSO application server module 120, which in turn stores the data in the SSO database module 124. The SSO application server module 120 then retrieves the updated authentication data and sends it to the client 104 using the web server module 122 and the SSO agent 132. The authentication data is stored on the client 104 in the user profile 134 for future use by the SSO agent 132 residing on the client 104. Thereafter, as the user logs into an application in the usual fashion, the SSO agent 132 operates in the background, gathering and transmitting to the SSO server 108 all the information necessary to automate subsequent logins.

Alternatively, or in addition, the SSO agent 132 may reside on a server. This embodiment is particularly useful in a “thin-client” environment, such as CITRIX METAFRAME. In this embodiment, a user U connects to a server where the SSO agent 132 resides. This server, in turn, communicates with the application server 106 and identification server 108. The displayed output (such as HTML or screen dumps, for example) is obtained indirectly from the application server 106, by way of the server on which the SSO agent 132 resides; that is, this additional server runs the SSO agent 132 and passes back the display information (as pixel values, markup code, or any other suitable display modality) to the client 104.

The user profile 134 can contain various data furthering the function of the invention, such as: a user identification code; an authentication modality (such as password, biometric data, or the like); an application profile (such as a user's rights and privileges within an application); an application credential for access (such as a user's password, a digital representation of biometric data, or the like); and for audit records of a user's activities within an application. The SSO agent 132 can then use the data stored in the user profile 134 to determine which HTTP requests to intercept, to complete login screens with stored authentication data, and the like.

As one example, a human resources application may include sensitive, personal information about employees, and therefore only individuals having proper authorization to use the application are granted access. In instances in which the application is web-based, users navigating to the launch page of the application may be presented with an HTML page having one or more fields in which to enter authentication information. By recognizing the URL as representative of a particular application, or by recognizing individual elements drawn on the screen (e.g., the work “password” and/or “User ID”) the SSO agent 132 can automatically supply the necessary credentials and free the user from having to remember or enter such information.

In the illustrated embodiment, certain security measures may be employed to prohibit listening devices from capturing authentication data, or if the data is captured, that it is not usable by itself. For example, the SSO agent 132 can encrypt the alias and the biometric data independently; the SSO agent 132 and the SSO database 124 can communicate with each other using the secure socket layer (SSL) and/or public and private keys; and/or the SSO agent 132 can transmit the alias and the authentication data independently to the SSO database 124. However, certain malware applications may still pose a threat to the security of authentication credentials.

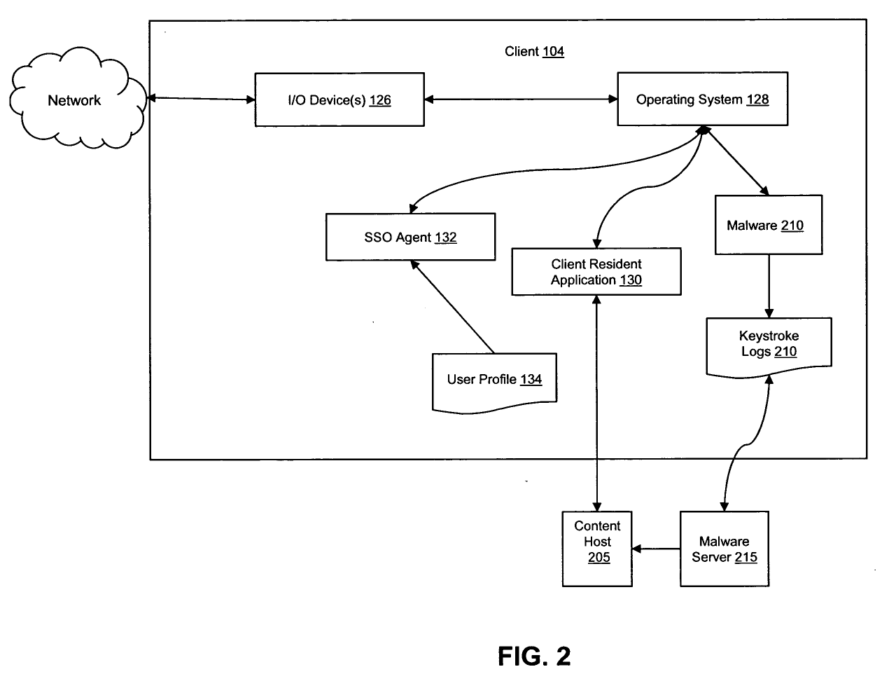

FIG. 2 provides one example of how keystroke-logging malware is typically delivered to the client 104. An operator of client 104 using, for example, client application 130 directs the application 130 to a content host 205 to retrieve content, use an application, or perform some other function whereby the client 104 and host 205 interact. In one particular example, application 130 is an Internet browser and the content host 205 may be a publicly available web site that includes items for sale and advertisements. As the operator navigates through the site, application 130 sends HTTP commands to the host 205 requesting the various pages, which are served to the client and displayed via application 130.

However, unbeknownst to the operator of the client 104 (and in some cases even the entity responsible for the maintenance of the content host 205), individual pages (or in some cases the entire site) provide the conduit through which malware may be delivered to the client 104. For example, a web site may offer portions of each web page (e.g., banner ads) to advertisers and affiliates or in some cases allow advertisers to briefly obfuscate the an entire page as the client application renders the page (e.g., pop-up ads). In most cases, the content host 205 has little or no control over the actual ads that are delivered, and in some cases the ads may include commands, applications, or scripts that, when executed, deliver some form of malware application 210 to the client 104. In other instances, malware may be delivered to the client in the process of downloading media (e.g., videos, songs, etc.). In still other cases in which the client application is a client-resident email application, any of the processes of receiving, downloading, opening or selecting contents of an email may send instructions to a malware server 215 to download malware 210 to the client 104. Accordingly, the types of malware and methods by which it can be delivered to a client are numerous, and the invention is not limited to any particular mode of delivery.

One particular form of malware that poses a significant threat to the security of identification and authentication information being processed on the client 104 is keystroke-logging malware. In its most basic form, keystroke-logging malware is a piece of rogue code that is inadvertently downloaded and becomes embedded on the client machine. This malware typically monitors keyboard commands as they are sent between an application and an operating system. In WINDOWS-based systems, for example, keyboard logging malware relies on a feature of the operating system that allows the malware to “hook” a callback function into the internal messaging system and, as a result, the callback function is notified each time the user enters a keystroke. The operating system activates the callback function each time a character is pressed and provides the logger with an effective way to monitor keystrokes entered by the user for all applications. With adequate offline processing, the captured and uploaded information can reveal critical account information that can be used for fraudulent purposes.

For example, a user interacting with an e-commerce web site may enter information such as her name, mailing address, email address, telephone number, credit card number, user name, password as well as other sensitive and/or potentially exploitable information. While the information is transmitted to the site in a secure manner, and there is little risk of interception or theft based solely on the interaction with the e-commerce site, the keystroke-logging malware poses a significant risk. As she enters the information via her keyboard, the individual keystroke commands are sent to the operating system via a messaging queue, for example. The malware, often operating as a rootkit or some other hidden utility such as a hooking file, intercepts the keystroke commands and either writes the commands to client-resident file, transmits the commands to a remote server, or in some cases, both. Once captured, the commands can be analyzed to determine which are routine and which sequences represent valuable information. Such malware is of particular concern to entities that employ SSO systems such as those described above, because one method of providing automated login and user authentication includes the emulation of keystroke commands and the processing of such commands using the very messaging and application queues targeted by keystroke-logging malware.

Although certain anti-virus and anti-spyware software may be able detect and quarantine keyboard loggers, such detection typically requires enough samples of the malware to generate a signature that can be used during system scanning processes. Unfortunately, such scans are typically performed after sensitive information has been compromised.

To combat this threat, the invention provides techniques and systems that safeguard sensitive information while still allowing SSO applications to operate as designed by maintaining a list of “approved” applications. In general, the memory address of each approved application is identified and stored, and the transmission of keyboard commands is limited to those memory addresses.

In regular operation, operating systems such as Microsoft WINDOWS typically pass keyboard events to registered callbacks within a call chain. As such, keystroke commands entered by an SSO agent are processed by the operating system even if one of the callbacks belongs to a keyboard logger, since the SSO agent has no way to distinguish between a legitimate application that uses a keyboard event and a fraudulent keyboard logger. In accordance with the present invention, the SSO agent instructs the wrapper function to pass the call argument to the original callback function only if it is within the identified list of authorized target applications 310. If it is not within that list, the call argument is blocked by the SSO agent 132, ensuring that the user's credentials will not be compromised by malware 210 such as a keyboard logger 210.

As an example implementation, callback functions may be injected into running applications so that when a keystroke command is generated by the user for the application, the operating system looks up the call chain for that application and passes the keystroke command to the first callback in the call chain. When completed, the first callback calls the second callback function in the chain, and this process continues until all callbacks in the chain have been called. In one implementation, wrapping may be used to allow an application to register its own callback with the system. In such cases, the process of identifying each application and the memory address of its callback function facilitates the mapping of the application to a particular memory address. For example, this mapping may be made at the time of the initial system call when the application makes the SetWindowsHook call to register its particular callback function. By wrapping the SetWindowsHook function, the process making the call and the memory address at which the callback function resides becomes known.

In one implementation, when the SSO agent is either capturing keystrokes or entering them automatically, the SSO agent has available to it a listing of the process identifiers for all legitimate recipients. Process identifications may be session unique identifiers that are obtained from the operating system through well-known calls. Similarly, the association between a function address and the process to which it belongs may be determined by enumerating the symbol table for each loaded process to see if it exists. As such, linking the callback address and process identification for an application may be used to selectively determine if a keystroke command should be passed during either SSO capture or proxy operations. For example, legitimate recipients of callback messages may include the target SSO application, the SSO agent itself and/or child processes spawned by the target SSO application.

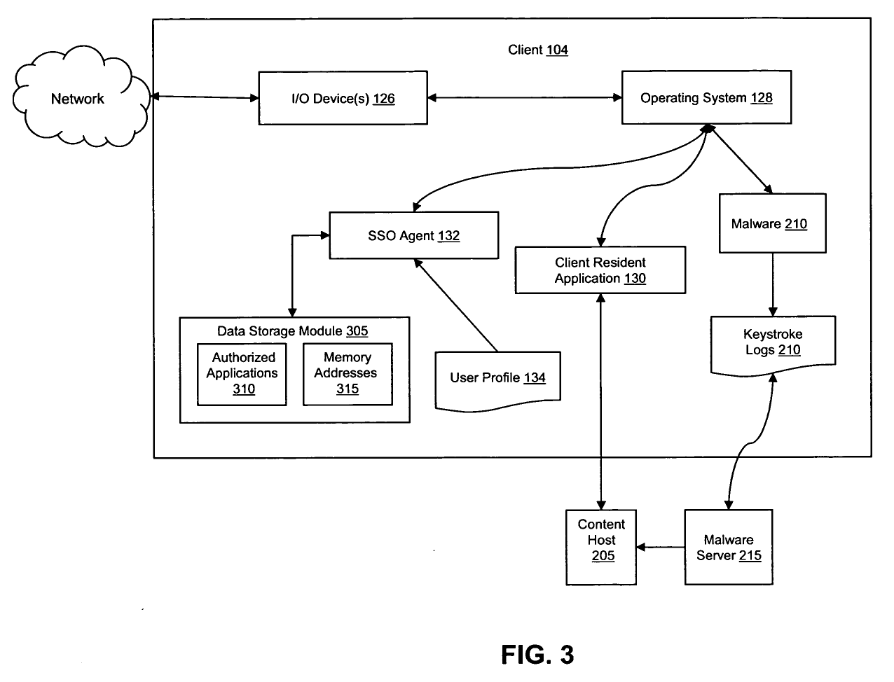

Referring to FIG. 3, authorized applications 310 and their corresponding memory addresses 315 are identified. The applications and their memory addresses may be stored as a list on the client 104 in a data storage module 305, or stored on a server and transferred to the client periodically, or stored on a server and transferred to the client upon login by a user. Accordingly, when a user initiates an application by, for example, opening an Internet browser or accessing a word-processing application, the filename associated with the application may be compared against the list of authorized applications 310. For example, the filename WINWORD.EXE (corresponding to Microsoft WORD) may be listed as an authorized application, along with the libraries and/or application extensions (e.g., DLLs) used by the executable file. Once a memory address (or addresses) at which the files for the authorized application reside is determined, a list of memory addresses 315 may be stored on the client, on a server and transferred to the client periodically, or on a server and transferred to the client upon login by a user, or as shown in FIG. 3, stored in the data storage module 305. Thus, when keystrokes representing login credentials, passwords, or critical account information are manually entered by a user or automatically provided by an SSO application, the memory address (or addresses) for the application or file to which the keystrokes are to be sent is determined and compared to the list of memory addresses 315. As a result, a determination can be made as to the legitimacy of the application or file prior to transmission of sensitive data. In one example, only when the destination memory address of the target application matches an approved memory address are the keystrokes delivered to the application. This provides an active defense against potential loss of privacy and confidential information through keyboard logging and protects application credentials that are critical to the functionality of SSO applications.

In one example, a client-resident SSO agent “hooks” into the keyboard logger through the WINDOWS hooking mechanism. The term hooking, as used herein, refers to the technique of creating a chain of procedures to serve as a handler for a particular event or set of events (such as a keystroke entry). After the handled event occurs, the control flow follows the procedure chain in the specified order. Hooking allows for the registration of a substitute address as handler for the event and may, under certain circumstances, call the original handler (e.g., a keystroke-handling process). Since keyboard loggers attempt to register callback functions in order to capture keystrokes, the SSO agent substitutes a wrapper function for the callback functions as a hook, thus creating a layer between the original function and the operating system. Each time a keyboard callback function is invoked, the wrapper function receives the call instead of the original callback function registered by the keyboard logger. Thus, a wrapper function either calls the original callback function if the destination address is associated with an approved application and the keystroke command is delivered to the application, or, if the destination address is not associated with an approved application, the wrapper function bypasses the original callback and blocks the keystroke command, thereby preventing the keyboard event from reaching the logger.

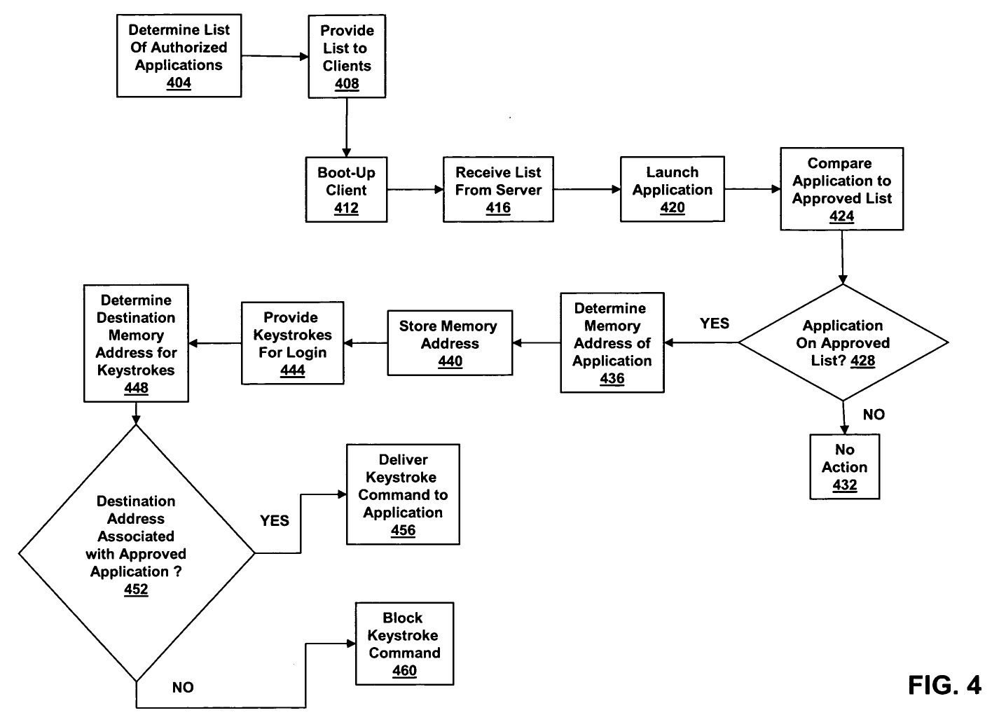

FIG. 4 illustrates one exemplary process for safeguarding keystrokes provided to applications. First, a list of authorized applications is determined (STEP 404) and provided to clients (STEP 408) that may use the applications. When a client is booted up (STEP 412) and connects to a network, a list of authorized application file names is received from the server (STEP 416). When an application is later initiated (STEP 420), the filename for that application is compared to the approved list (STEP 424). If the application file name is not on the approved list, no action is taken (STEP 432). If, however, the application filename is on the approved list, the memory address of the application is determined (STEP 436) and stored (STEP 440) on the client for reference during subsequent interactions between the operating system and the application. When keystrokes are provided (during an automated login by an SSO application, for example) (STEP 444), the destination memory address for the keystrokes is determined (STEP 448). If the destination address is associated with an approved application, the keystroke command is delivered to the application (STEP 456), whereas if the destination address is not associated with an approved application, the keystroke command is blocked (STEP 460).

Active blocking may take place when the agent is in either capture or proxy mode. During capture mode, the SSO agent attempts to learn logon credentials for an application and uses keyboard hooking to obtain the keystrokes in the same manner as a keyboard logger, except the SSO agent is a legitimate user. In proxy mode, the SSO agent injects the previously learned credentials into the application for the purpose of logging into an application. Preventing the callbacks from being called by the system in both situations effectively blocks the keyboard logger from gaining access to the keystrokes used to enter the credentials.

By using an application's memory address (or addresses) to determine when the callback function is called or bypassed, the invention facilitates the determination of whether keystroke commands are being sent to a trusted or untrusted application, thereby avoiding the serious security threat presented by malware, and particularly keyboard-logging malware. As a result, the invention provides an effective way to protect secure systems from malicious behavior, particularly when sensitive information is submitted to applications on the systems.

While the invention has been particularly shown and described with reference to specific embodiments, it should be understood by those skilled in the area that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for handling keystroke commands, the method comprising:
monitoring keystroke commands being presented to a computer system; and
handling keystroke commands based on a memory address attributed to an application to which the keystroke commands are being directed.

2. The method of claim 1, wherein the keystroke commands comprise logon credentials.

3. The method of claim 2, wherein the logon credentials facilitate automation of a logon procedure.

4. The method of claim 3, wherein the automation of the logon procedure comprises injecting user credentials into a form.

5. The method of claim 1, wherein the monitoring of the keystroke commands further comprises intercepting messages in a message queue.

6. The method of claim 5, further comprising the step of providing a client agent for intercepting the messages.

7. The method of claim 6, wherein the client agent intercepts the messages by hooking into the message queue.

8. The method of claim 7, wherein the client agent hooks into the message queue by substituting a wrapper function in the place of a callback function.

9. The method of claim 6, wherein the client agent processes the keystroke commands based at least in part on how they are handled.

10. The method of claim 9, wherein the client agent calls the callback function based at least in part on how the keystroke commands are handled.

11. The method of claim 9, wherein the client agent bypasses the callback function based at least in part on how the keystroke commands are handled.

12. The method of claim 11, wherein bypassing the callback function results in blocking an operating system from processing the keystroke commands.

13. The method of claim 1, wherein handling keystroke commands results in safeguarding keystroke commands from malware.

14. The method of claim 1, further comprising determining if the application to which the keystroke commands are being directed is an authorized application.

15. A client-resident agent for handling keystroke commands entered via an input device and directed to a running application associated with a memory having a plurality of addresses, the agent comprising functionality for:
monitoring the keystroke commands; and
handling the keystroke commands based on a memory address associated with the application.

16. The client-resident agent of claim 15, wherein the keystroke commands comprise logon credentials.

17. The client-resident agent of claim 16, wherein the client-resident agent further comprises functionality for automating a logon procedure.

18. The client-resident agent of claim 17, wherein the client-resident agent automates the logon procedure by injecting user credentials into a form.

19. The client-resident agent of claim 15, wherein the client-resident agent monitors the keystroke commands by intercepting messages in a message queue.

20. The client-resident agent of claim 19, wherein the client-resident agent intercepts the messages by hooking into the message queue.

21. The client-resident agent of claim 20, wherein the client-resident agent hooks into the message queue by substituting a wrapper function for a callback function.

22. The client-resident agent of claim 21, wherein the client-resident agent calls the callback function based at least in part on how the keystroke commands are handled.

23. The client-resident agent of claim 21, wherein the client-resident agent bypasses the callback function based at least in part on how the keystroke commands are handled.

24. The client-resident agent of claim 23, wherein the client-resident agent bypasses the callback function, resulting in blocking an operating system from processing the keystroke commands.

25. The client-resident agent of claim 15, wherein the client-resident agent's handling of keystroke commands results in safeguarding keystroke commands from malware.

26. A system for handling keystroke commands entered via an input device and directed to a running application associated with a memory having a plurality of addresses, the system comprising:
a client-resident agent for:
monitoring the keystroke commands; and
handling the keystroke commands based on a memory address associated with the application; and
a data storage module for storing a list of authorized applications.

27. The system of claim 26, wherein the data storage module further stores a list of the memory addresses allocated to the authorized applications.

28. An article of manufacture having computer-readable program portions embodied thereon for handling keystroke commands, the article comprising computer-readable instructions for:
monitoring keystroke commands being presented to a computer system; and
handling keystroke commands based on a memory address attributed to an application to which the keystroke commands are being directed.
